(19) United States
(12) Patent Application Publication
(10) Pub. No.: US 2017/0328175 A1
(43) Pub. Date: Nov. 16, 2017

(54) Deposit Heater

(71) Applicant: Siemens Aktiengesellschaft, Muenchen (DE)

(72) Inventor: Dirk Diehl, Bubenreuth (DE)

(73) Assignee: Siemens Aktiengesellschaft, Muenchen (DE)

(21) Appl. No.: 15/527,583

(22) PCT Filed: Nov. 6, 2015
(86) PCT No.: PCT/EP2015/075915

§ 371 Date: May 17, 2017

(30) Foreign Application Priority Data
Nov. 19, 2014 (DE) 10 2014 223 621.5

(51) Int. Cl. E21B 36/04; E21B 43/24; H05B 6/10

(52) U.S. Cl. CPC E21B 36/04; H05B 6/10; E21B 43/2401; H05B 2214/03

(57) ABSTRACT

The present disclosure relates to a deposit heater for heating an area of ground. The teachings thereof may be embodied, in particular, in inductive heaters useful for an oil sand, oil shale, extra-heavy oil, or heavy oil deposit. Some embodiments may include a deposit heater comprising: a first AC generator; a second AC generator; and an electrical conductor loop arranged at least partially within the area of ground. The conductor loop may be coupled to both generators. The first generator provides a first alternating current to a first region of the conductor loop and the second AC generator provides a second alternating current to a second region of the conductor loop.

### CROSS-REFERENCE TO RELATED APPLICATIONS

This application is a U.S. National Stage Application of International Application No. PCT/EP2015/075915 filed Nov. 6, 2015, which designates the United States of America, and claims priority to DE Application No. 10 2014 223 621.5 filed Nov. 19, 2014, the contents of which are hereby incorporated by reference in their entirety.

### TECHNICAL FIELD

The present disclosure relates to a deposit heater for heating an area of ground. The teachings thereof may be embodied, in particular, in inductive heaters useful for an oil sand, oil shale, extra-heavy oil, or heavy oil deposit.

### BACKGROUND

In-situ extraction of hydrocarbons from a subterranean deposit, for example extracting heavy oils or bitumen from oil sand or oil shale reserves, is improved when the hydrocarbons that are to be extracted attain a maximum degree of flowability. To improve the flowability of the hydrocarbons at the time of their extraction, systems and methods to increase the temperature prevailing in the area of ground containing the deposit may include a deposit heater. One method for increasing the temperature of the deposit or, as the case may be, of the area of ground includes heating by means of an inductor introduced into the deposit. The inductor serves as a means of inducing eddy currents in electrically conductive deposits, which eddy currents heat up the deposit, thereby resulting in an improvement in the flowability of the hydrocarbons present in the deposit.

### SUMMARY

Typically, high heating capacities are required to obtain a sufficient increase in the temperature of the area of ground. Due to the high voltage amplitude occurring, the inductor must be electrically insulated from the area of ground to an adequate extent. The electrical insulation of the inductor limits the maximum thermal output and thereby the heater's heating capacity.

Some embodiments of the present teachings may increase the maximum thermal output. For example, some embodiments may include a deposit heater (1) for inductively heating an area of ground (46) which comprises at least one first and second AC generator (21, 22) and an electrical conductor loop (4) which is arranged at least partially within the area of ground (46), characterized in that the conductor loop (4) is electrically coupled to the first and second AC generator (21, 22) in such a way that the conductor loop (4) can be acted on by a first alternating current by means of the first AC generator (21) in a first region (31) and by a second alternating current by means of the second AC generator (22) in a second region (32).

In some embodiments, the first and second region (31, 32) are arranged disjunctly along the conductor loop (4).

In some embodiments, the first and second AC generator (21, 22) are arranged outside the area of ground (46).

In some embodiments, the first AC generator (21) is arranged outside, and the second AC generator (22) inside, the area of ground (46).

In some embodiments, conductor sections (44, 45) of the conductor loop (4) which are arranged between the first and second AC generator (21, 22) are embodied identically in terms of their conductor length.

In some embodiments, the first and/or second AC generator (21, 22) comprise/comprises a frequency converter.

In some embodiments, the first and second AC generator (21, 22) are spaced apart at a distance of at least 100 m.

Some embodiments may include a method for operating a deposit heater (1), wherein a first AC generator (21) generates a first alternating current and a second AC generator (22) generates a second alternating current, and wherein a conductor loop (4) which is arranged at least partially within an area of ground (46) is acted on by the first alternating current in a first region (31) and by the second alternating current in a second region (32).

In some embodiments, the first and second AC generator (21, 22) are operated in phase-locked mode.

In some embodiments, the first and second alternating current are generated at the same frequency.

In some embodiments, the first and second alternating current are generated at the same voltage amplitude.

In some embodiments, the first and second alternating current are generated at a frequency in the range of from 10 kHz to 200 kHz.

In some embodiments, the first and second alternating current are generated at a voltage amplitude of at least 10 kV.

Some embodiments may include use of a deposit heater (1) as described above for lowering the viscosity of a hydrocarbon-containing substance that is present in an area of ground (46).

### BRIEF DESCRIPTION OF THE DRAWINGS

Further advantages, features, and details of the disclosure will become apparent from the exemplary embodiments described herein below as well as with reference to the schematic drawings, in which:

FIG. 1 shows a three-dimensional view of a deposit heater which comprises two AC generators for operating a conductor loop;

FIG. 2 shows a simplified equivalent electrical circuit diagram of the deposit heater from FIG. 1; and

FIG. 3 shows a simplified equivalent electrical circuit diagram of a deposit heater which comprises four AC generators for operating a conductor loop.

Similar or equivalent elements may be labeled with the same reference signs in the figures.

### DETAILED DESCRIPTION

A deposit heater for inductively heating an area of ground may comprise at least one first and second alternating-current (AC) generator and an electrical conductor loop which is arranged at least partially within the area of ground. According to the invention, the conductor loop is electrically coupled to the first and second AC generator in such a way that a first alternating current can be applied to act on the conductor loop in a first region by means of the first AC generator and a second alternating current can be applied to act on the conductor loop in a second region by means of the second AC generator.

In some embodiments, the electrical power feed, that is to say, the application of an alternating electric current acting on the conductor loop, is effected by means of a first and second AC generator. In this case the first AC generator may be arranged at the first region and the second AC generator is preferably arranged at the second region of the conductor loop. At least two AC generators (first and second AC generator) are therefore provided to supply electrical power to the conductor loop.

In some embodiments, voltage amplitudes at the AC generators which are provided for applying or feeding the first and second alternating current to the conductor loop are thereby reduced, in particular halved, compared to supplying the conductor loop with electrical power by means of a single AC generator. In some embodiments, reducing the voltage amplitudes at the AC generators results in the insulation of the conductor loop being subjected to a lower electrical load, such that the maximum heating capacity of the deposit heater is increased for a given insulation of the conductor loop. This means that maximally optimal use is made of the limited and already existing insulation or insulation capability of the conductor loop. If it is aimed not to increase the maximum heating capacity of the deposit heater, then the electrical insulation of the conductor loop may be reduced in terms of its electrical insulation capability owing to the reduction in the voltage amplitudes.

The requirements imposed on the electrical insulation within the AC generators can also be reduced. For a given insulation or insulation capability of the conductor loop, the maximum heating capacity, which is limited by the cited insulation, can be increased, by a factor of two, for example, by means of the dual feeding of the conductor loop with alternating current (first and second alternating current).

In some embodiments, the conductor loop extends from the first AC generator to the second AC generator and from the second AC generator back to the first AC generator. As a result, the conductor loop comprises a first conductor section and a second conductor section. The first conductor section extends from the first AC generator to the second AC generator. The second conductor section extends from the second AC generator to the first AC generator. The first and second conductor section accordingly form the conductor loop.

Some embodiments may include a method for operating a deposit heater, in which a first AC generator generates a first alternating current and a second AC generator generates a second alternating current. In some embodiments, a conductor loop which is arranged at least partially within an area of ground is acted on by application of the first alternating current in a first region and by application of the second alternating current in a second region. In other words, a dual electrical power feed is provided for the conductor loop for inductively heating the area of ground. This results in similar and equivalent advantages to the already cited deposit heater.

Some embodiments include use of a deposit heater as described above to reduce the viscosity of a hydrocarbon-containing substance that is present in an area of ground.

The hydrocarbon-containing substance can comprise heavy oils, extra-heavy oils, bitumen, oil sand, and/or oil shale. As a result of using the deposit heater, the area of ground may be heated, along with the substance present in the area of ground, thereby reducing the viscosity of the substance. In other words, using the deposit heater may lead to an increase or improvement in the flowability of the hydrocarbon-containing substance. The hydrocarbon-containing substance comprises at least hydrocarbons which are destined for extraction, in particular for in-situ extraction.

In some embodiments, the first and second region may be arranged disjunctly along the conductor loop. In such embodiments, a first alternating current is applied to act on the conductor loop at a first point by means of the first AC generator and the second alternating current is applied to act on the conductor loop at a second point that is different from the first point by means of the second AC generator. A dual application or feeding of alternating electric current to the conductor loop is therefore realized at two different points or in two different regions of the conductor loop. In some embodiments, the first and second AC generator are not arranged one immediately after the other, i.e. they are spaced apart at a generous distance from each other. In some embodiments, the first and second AC generator are arranged outside the area of ground. As a result, the AC generators may be arranged spaced apart at a distance from each other without further boreholes. Furthermore, arranging the AC generators above ground allows easy access to the AC generators, for maintenance activities, for example.

In some embodiments, the second AC generator may be arranged in a region (second region) of the conductor loop which, given a predefined geometry of the conductor loop, is spaced at as far a distance as possible from the first AC generator, i.e. from the first region. This may provide that the geometry of the conductor loop is not modified or compromised by the presence of the second AC generator. In particular, owing to the dual electrical power feed, the conductor loop does not need to be lengthened, or needs to be lengthened only slightly, compared to a single electrical power feed.

In some embodiments, the first AC generator is arranged outside, and the second AC generator inside, the area of ground. The underground arrangement of the second AC generator enables the waste heat of the second AC generator that is generated during the operation of the second AC generator to be introduced into the area of ground surrounding the second AC generator. In other words, the heating of the area of ground may be improved or assisted by the second AC generator arranged in the area of ground. Conversion losses occurring in the second AC generator therefore remain in the deposit or, as the case may be, in the area of ground.

In some embodiments, conductor sections of the conductor loop, which conductor sections are arranged between the first and second AC generator, are embodied identically in terms of their conductor length. In other words, the first and second AC generator are arranged symmetrically along the conductor loop. In such an arrangement, the first conductor section extends from the first AC generator to the second AC generator and the second conductor section from the second AC generator back to the first AC generator. The first and second conductor section have approximately the same conductor length. The conductor loop is therefore supplied with electrical power by means of the two AC generators in a manner that is symmetrical in terms of the length of the conductor loop. As a result, the voltage amplitudes at the AC generators and/or in the first and second conductor section may be approximately halved compared to a single electrical power feed.

In some embodiments, the first and/or second AC generator comprise/comprises a frequency converter. The frequency of the first and/or second alternating current may be matched to a resonance frequency of the conductor loop. To embody a resonant electrical circuit, e.g., a series resonant electrical circuit with a resonance frequency, the conductor loop may include at least one capacitor. The inductance of the resonant electrical circuit is formed by the inductance of the conductor loop itself. By means of the frequency converter it is possible to match the frequency of the electrical power feed to the resonance frequency of the conductor loop so that a reactive power compensation results in resonance.

If the second AC generator is arranged within the area of ground, then the conversion losses of the frequency converter, which typically amount to between one and ten percent of the total output of the frequency converter, are dispersed to the area of ground. The conversion losses are introduced directly into the area of ground, thereby producing an additional heating effect on said area of ground.

In some embodiments, the first and second AC generator may be spaced apart at a distance of at least 100 m. This may enable an extensive and/or large-scale heating of the area of ground by means of the conductor loop.

In some embodiments, the first and second AC generator are operated in phase-locked mode. A phase-locked operation of the first and second AC generator is characterized in that the phase difference between the phase of the first and second alternating current does not vary or varies only marginally with respect to time. In this case, the phase difference between the first and second alternating current may be 0° or 180°, where 0° is appropriate if the AC generators have the same polarity and 180° if the AC generators have opposite polarity. This may provide that an addition of the voltage amplitudes takes place, and not a mutual cancellation (difference) of the voltage amplitudes of the AC generators.

In some embodiments, the first and second alternating current are generated at the same frequency. This may enable an overlaying of the alternating currents with substantially one frequency. At a fixed phase difference between the first and second alternating current, these already have the same frequency.

In some embodiments, the first and second alternating currents have the same voltage amplitude. As a result, the conductor loop is supplied with electrical power symmetrically in terms of the voltage amplitudes. In some embodiments, a first and/or second alternating current are/is applied to act on the conductor loop, where the frequency of the first and/or second alternating current lies in the range of from 10 kHz to 200 kHz.

A frequency in the cited 10 kHz to 200 kHz range that corresponds to the resonance frequency of the conductor loop may provide improved performance, wherein the conductor loop comprises at least one capacitor in order to form a resonant electrical circuit. A reactive power compensation can be achieved as a result. Furthermore, the frequency of the alternating currents taught herein is relatively low compared to known methods of deposit heating. This enables safety distances, the observation of which is mandatory at higher frequencies, to be reduced. The safety of the deposit heater is improved as a result.

Some embodiments may include a voltage amplitude of the first and second alternating current amounting to at least 10 kilovolts (10 kV). This may allow a high first and second alternating current of at least 100 amperes (100 A), thereby ensuring a heating capacity delivering at least one megawatt (1 MW).

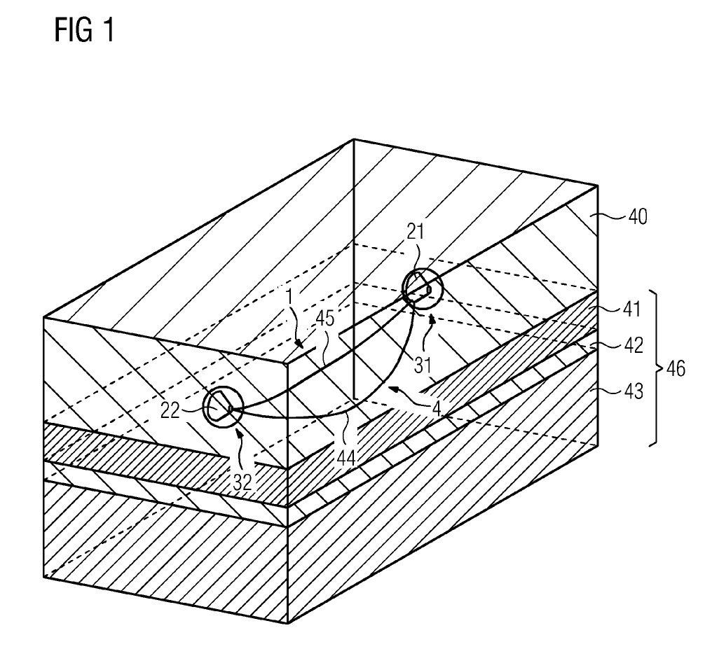

FIG. 1 shows a schematic three-dimensional view of a deposit heater 1, which comprises a first and second AC generator 21, 22 for operating a conductor loop 4. The conductor loop 4 is introduced at least partially into an area of ground 46 of the deposit. The area of ground 46 comprises a hydrocarbon-containing substance, i.e. hydrocarbons that are to be extracted, for example heavy oils, extra-heavy oils, bitumen, oil sand and/or oil shale. The area of ground 46 may furthermore encompass a geological formation and/or a hydrocarbon-bearing earth layer 42, in particular a plurality of earth layers 41, . . . ,43.

The conductor loop 4 extends at least through and/or within an earth layer 42 containing the hydrocarbons that are to be extracted, e.g., heavy oils, extra-heavy oils, bitumen, oil sand, or oil shale reserves. The hydrocarbon-bearing earth layer 42 is surrounded by an overlying earth layer 41 thereabove and an underlying earth layer 43 therebelow. The area of ground 46 comprises the cited earth layers 41, . . . ,43.

The conductor loop 4 provides an inductor 4, the conductor loop 4 having been introduced into the area of ground 46, at a depth of 50 m to 85 m, for example. In this arrangement, the conductor loop 4 has a plurality of capacitors for a resonant electrical circuit provided for reactive power compensation purposes. The conductor loop 4 may also include a first and a second conductor section 44, 45. The first conductor section 44 extends from the first AC generator 21 to the second AC generator 22. The second conductor section 45 extends from the second AC generator 22 back to the first AC generator 21. In this arrangement, the first and second conductor section 44, 45 form the conductor loop 4.

The first AC generator 21 is arranged in a first region 31 and the second AC generator 22 in a second region 32 of the conductor loop 4. The first and second conductor section 44, 45 reach their greatest distance apart, for example of 50 m, in the earth layer 42, which contains the hydrocarbons that are to be extracted.

The first and second AC generator 21, 22 are arranged outside the area of ground 46 and within an air layer 40 surrounding the deposit 1. The first and second AC generator 21, 22 are operated in phase-locked mode wherein the phase difference between the first alternating current generated by means of the first AC generator 21 and the second alternating current generated by means of the second AC generator 22 does not vary or varies only slightly with respect to time. In this case, a fixed phase difference of 0° or 180°, according to the polarity of the first and second AC generator 21, 22, may be used. The alternating currents generated by means of the first and second AC generator 21, 22 have the same frequency and current amplitude. In some embodiments, the first and second AC generator 21, 22 have approximately the same voltage amplitude, it being possible for different voltage amplitudes to be provided.

The conductor loop 4 can furthermore be fed with electrical power by means of more than two AC generators. In some embodiments, the respective voltage amplitudes at the AC generators and in the conductor sections between the AC generators are reduced further as a result. Supposing, for example, that N AC generators are used, then the electrical requirements imposed on the insulation of the conductor loop 4 from the area of ground 46 can be reduced by a factor of 1/N if the active voltage is higher than the reactive voltage of the respective conductor section between two AC generators in each case. In this example, N is a natural number that is greater than or equal to two. At least some of the N AC generators may be arranged within the area of ground 46. This means that losses, for example conversion losses of frequency converters arranged in the AC generators, may be dispersed to the area of ground 46.

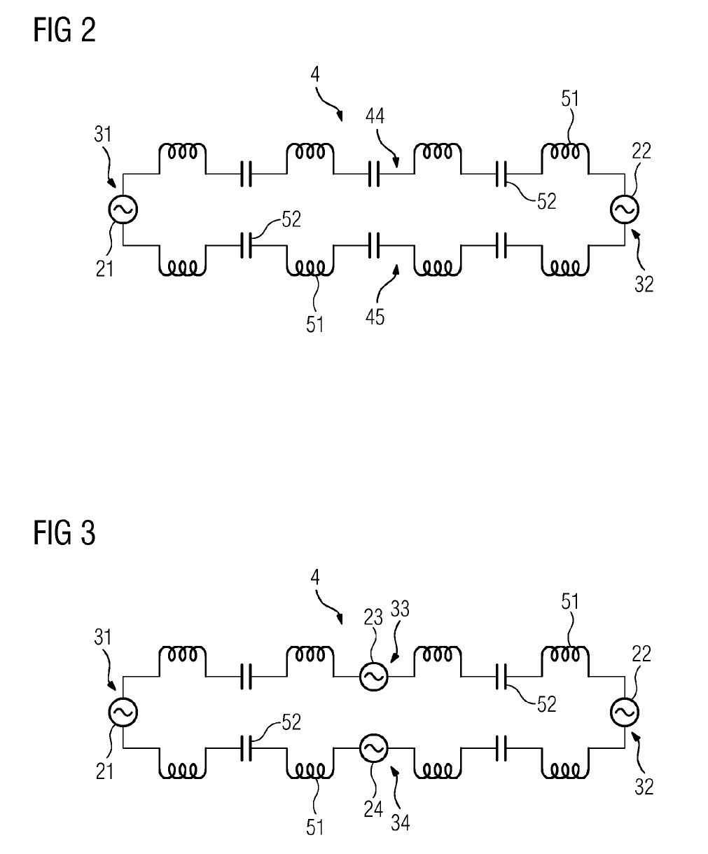

FIG. 2 shows a schematic diagram of an equivalent electrical circuit for the conductor loop 4 from FIG. 1. In this arrangement, the conductor loop 4 comprises a plurality of capacitors 52. The inductors 51 include the conductor loop 4 itself. In the first and second region 31, 32 of the conductor loop 4, an alternating current is applied to act on the conductor loop 4 in each case by means of the AC generators 21, 22, respectively. The capacitors 52 and inductors 51 combine to embody a series resonant electrical circuit having a resonance frequency that is predefined by the capacitors 52 and inductors 51. In some embodiments, the first and second AC generator 21, 22 are operated at the resonance frequency of the cited series resonant electrical circuit. This results in a reactive power compensation.

The first and second AC generator 21, 22 are arranged symmetrically in terms of the conductor length of the conductor loop 4, which is to say that the first conductor section 44 has substantially the same conductor length as the second conductor section 45.

FIG. 3 shows a schematic diagram of an equivalent electrical circuit for a conductor loop 4 to which an alternating current is applied in each case in four regions 31, . . . ,34. For this purpose the conductor loop 4 is electrically coupled to a first, second, third and fourth AC generator 21, . . . ,24. The conductor sections lying between two AC generators in each case may have the same conductor length. In other words, the AC generators 21, . . . ,24 are arranged symmetrically along the conductor loop 4. They therefore subdivide the conductor loop 4 into the equal-length conductor sections.

As already illustrated in FIGS. 1 and/or 2, the conductor loop 4 includes a plurality of capacitors 52 and inductors 51 for embodying a series resonant electrical circuit. The third and fourth AC generator 33, 34 can be arranged in the area of ground 46 (underground).

Generally, the conductor loop 4 can be electrically coupled to more than four AC generators. In other words, an N-times feeding of electrical power to the conductor loop 4 is realized. The electrical requirement imposed in terms of the insulation of the conductor loop 4 from the area of ground 46 can be reduced by a factor of 1/N as a result.

Although the teachings herein have been illustrated and described in greater detail on the basis of the exemplary embodiments, they are not limited to the disclosed examples. Other variations may be derived herefrom by the person skilled in the art without departing from the scope of the teachings.

What is claimed is:

1. A deposit heater for heating an area of ground, the deposit heater comprising:
a first AC generator;
a second AC generator; and
an electrical conductor loop arranged at least partially within the area of ground;
wherein the conductor loop is electrically coupled to the first and second AC generator;
the first AC generator provides a first alternating current to the conductor loop in a first region of the conductor loop and the second AC generator provides a second alternating current to the conductor loop in a second region of the conductor loop.

2. The deposit heater as claimed in claim 1, wherein the first and second region are arranged disjunctly along the conductor loop.

3. The deposit heater as claimed in claim 1, wherein the first and second AC generator are arranged outside the area of ground.

4. The deposit heater as claimed in claim 1, wherein the first AC generator is arranged outside the area of ground and the second AC generator is arranged inside the area of ground.

5. The deposit heater as claimed in claim 1, wherein sections of the conductor loop arranged between the first and second AC generator have an equivalent conductor length.

6. The deposit heater as claimed in claim 1, wherein the first AC generator comprises a frequency converter.

7. The deposit heater as claimed in claim 1, wherein the first and second AC generator are separated by a distance of at least 100 m.

8. A method for heating a deposit within an area of ground, the method comprising:
generating a first alternating current with a first AC generator and applying the first alternating current to a first region of a conductor loop; and
generating a second alternating current with a second AC generator and applying the second alternating current to a second region of the conductor loop;
wherein the conductor loop is arranged at least partially within the area of ground.

9. The method as claimed in claim 8, wherein the first and second AC generator are operated in phase-locked mode.

10. The method as claimed in claim 8, wherein the first and second alternating current have the same frequency.

11. The method as claimed in claim 8, wherein the first and second alternating current have the same voltage amplitude.

12. The method as claimed in claim 8, wherein the first and second alternating current have a frequency in the range of from 10 kHz to 200 kHz.

13. The method as claimed in claim 8, wherein the first and second alternating current have a voltage amplitude of at least 10 kV.

14. (canceled)
